(19) United States
(12) Patent Application Publication
(10) Pub. No.: US 2010/0211642 A1
(43) Pub. Date: Aug. 19, 2010

(54) Method of Communication Among Groups

(76) Inventor: William D. Campagna, Mineola, NY (US)

Correspondence Address: GREENBERG & LIEBERMAN, LLC, 2141 WISCONSIN AVE, N.W., SUITE C-2, WASHINGTON, DC, 20007, US

(21) Appl. No.: 12/372,517

(22) Filed: Feb. 17, 2009

(51) Int. Cl. G06F 15/16

(52) U.S. Cl. 709/206; 709/204

(57) ABSTRACT

An online method of communication between separate groups or organizations where such communications are collective in nature as opposed to emanating from merely individual members. Such communications or transmittals of information emanate from the collective group and ultimately are received by another group. That receiving group may then respond as a collective group. This means that there is no individual interaction between members of the groups.

### FIELD OF THE INVENTION

The present invention relates to an online method of communication between separate groups or organizations where such communications are collective in nature as opposed to emanating from merely individual members.

### BACKGROUND OF THE PRESENT INVENTION

As online social networks continue to evolve, there is an increasing demand for group activities. This is evident by the fact that various Internet sites offer some sort of group involvement. For example, GOOGLE™ has a popular message board system where individual members can join a group of likeminded individuals. In this manner, the individual members can communicate with other members of their group or post the message to all members of this specific group. Moreover, the online social networking sites MYSPACE.COM and FACEBOOK.COM also allow groups to be created with individual involvement. In each of these formats, individual members are permitted to communicate to the other members of the group either individually or to all. However, despite the usefulness of such online options, there continues to be a need for overall groups to have the ability to communicate directly with other overall groups in a collective manner as opposed to emanating from merely individual members.

The notion of communicating among overall groups is beneficial from both practical and monetizing reasons. Currently, online social networks only permit a sort of entropy as individual members of groups communicate among each other based on their own personalized and potentially uncoordinated manners. When a group member, to include the originator, of such online networks wishes to contact another group, he or she typically must contact the other group as an individual. This leaves no option for sustained official dialogue among actual groups. To that end, there is a need for an online method of communication between separate groups or organizations where such communications are collective in nature as opposed to emanating from merely individual members. The present invention solves this need.

For example, college students can use such a Web site for many different reasons. People find different friends from different colleges and it is so easy through existing social networking sites because the individual is merely one click away from interacting with that one person who can be from a school 3,000 miles away. But this existing system also precludes that individual from interacting with 30 people at one time who share the same interest as the individual or his or her group. In terms of party arranging, instead of sending out 500 personal invitations to each person about a party, a group can send 10 invites to groups as large as 50 people. These groups can range anywhere from 10 people to 50 in an example, although there is no limit to the amount of people allowed in a group.

The present invention also solves the need in the professional or business world. Currently, Web sites such as LINKEDIN.COM and NAYMZ.COM cater to individual professionals who can communicate with other members and link up with their own contacts. But again, there is no option for a business-to-business communication mechanism where the actual business can send a message to another actual business. For example, X Company can have 50 members or employees on a Web site. Y Company can have 4 members or employees. With a Web site such as envisioned for the present invention, X Company can offer up an official discussion with Y Company. There will be no individual input from any of the 50 members or 4 members from either company. The only communications will be official transmittal of information from the actual company entities. In addition, the present invention also serves to eliminate any confusion as to whether a group is speaking in its official capacity or whether it is merely an individual member speaking with a message that may not be endorsed by the overall group.

### SUMMARY OF THE PRESENT INVENTION

The present invention is an online method of communication among groups. Such communications or transmittals of information emanate from the collective group and ultimately are received by another group. That receiving group may then respond as a collective group. This means that there is no individual interaction between members of the groups.

How the present invention operates is that a group is created. Individuals then may join the group. A hierarchy within the group in the preferred embodiment has a moderator that can approve, deny, edit, and return any message proposed by a member of the group. The moderator aspect is a tiered system to offer backups for the top moderator. Ultimately, any message coming from the group is only designated as coming from the actual group and not any individual. The same goes for the receiving group.

The method of the present invention occurs on a server via online means such as a Web site or even Intranet site when dealing with meetings among separate groups or departments. Messages coming from the group will be officially listed with the group name.

### BRIEF DESCRIPTION OF THE PRESENT INVENTION

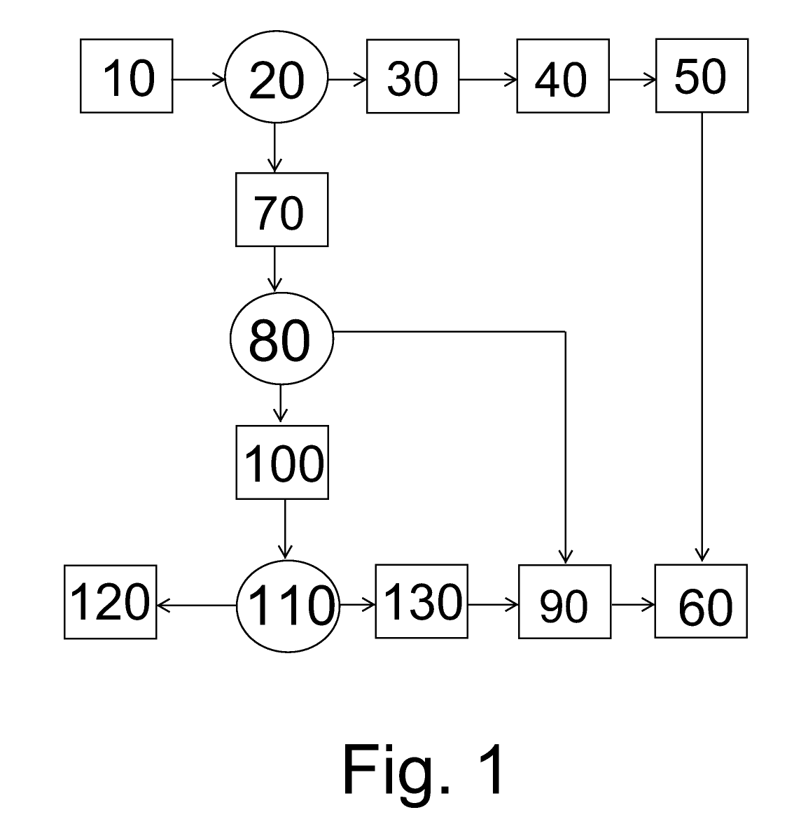

FIG. 1 is a flow chart of the method of the present invention

### DETAILED DESCRIPTION OF THE PRESENT INVENTION

FIG. 1 is a flow chart that details the steps a user may take in the preferred embodiment of the present invention. First, a user comes to the Web site (10). The user then has the option of joining a group or creating a new group (20). If the user is intent on starting a new group, the user will become the group administrator and will fill-out group information (30). This includes setting contact information. The group administrator then starts to fill out membership rosters (40). This element includes creating and sending emails. These emails are sent with pre-authorization codes. The group administrator can designate group properties and assign other administrators for the group (50). This includes the beginnings of a hierarchal structure. The user can then access group information and send/receive communications between groups (60). In the preferred embodiment of the present invention, the present invention is integrated into the hardware of a computer.

Relating to a user who is not a group administrator, that user comes to the Web site (10) and receives the option to join a group or create a new group (20). The user also is referred to as at least one user. Opting to join an existing group, the user will have the option to apply for membership or enter a pre-authorization code (70). The system of the present invention then determines whether or not the user is pre-authorized (80). If the user is pre-authorized, the user then is permitted to complete registration (90). Once registration is complete, the user can then access group information and send/receive communications between groups (60).

Relating to instances where the user applies for membership and is not pre-authorized, the application is transmitted to a group administrator or group administrators for approval (100). The group administrator or group administrators then have the option to accept or reject the application (110). If the application is rejected, the user is notified that they were not permitted access to the group (120). However, if the application is accepted, the user is notified that they have been accepted into the group (130). In the preferred embodiment, such notifications will be transmitted via email. Once a user is accepted into the group, the user is permitted to complete registration (90). From there, the user can then access group information and send/receive communications between groups (60).

Once the group is established, outgoing communications will be transmitted as a unitary group rather than via individual group members. In addition, group members will receive as a unitary group all communications transmitted toward the group. Advertising also may be included in the preferred embodiment where the advertisements are geared toward the general category, interest, nature or mission of the group. Such advertisements will be included on the Web site pages and communications transmissions via conventional means.

A hierarchy within the group in the preferred embodiment has a moderator that can approve, deny, edit, and return any message proposed by a member of the group. The moderator aspect is a tiered system to offer backups for the top moderator. In the preferred embodiment, the group administrator or group administrators can determine which group member will serve as the moderator. The hierarchy in the preferred embodiment is such that the message ultimately being transmitted comes from the group. This means that the at least one recipient does not necessarily know which individual had sent the communication, but only that the communication is coming from a specific group. It should be noted that the group administrator or group administrators can remove the hierarchy aspect so that any group member can transmit a communication from the unitary group to a recipient. Regardless of the embodiment, the group communicates with others as a unitary group.

It should be noted that in the preferred embodiment, the individual members is prevented from transmitting a message as an individual. This means that after the member completes registration (90), the user is blocked via conventional means from communicating through group assets or identifiers as an individual to anyone outside of that group. This means that an individual member or user cannot use their registered account to contact an entity outside of the group. Instead, the user's message will be routed to the group administrator or group administrators. From there, the hierarchy as described above will be put into motion. The initial message, if approved by the highest designated administrator or moderator, will then be transmitted as an official message of the group. Apart from any content contained within the body of the message, the message itself is identified to all outside observers and recipients as coming from the unitary group. It also should be noted, that in the preferred embodiment, the at least one recipient also is a second unitary group that receives the outgoing communication from the first unitary group through the manners described.

I claim:

1. An online method of communication, comprising:
creating a group via a group administrator on a server;
designating group properties;
authorizing at least one user, in addition to the group administrator, to join the group; and
transmitting an outgoing communication as a unitary group to at least one recipient, the at least one recipient receiving and viewing the outgoing communication as emanating from the unitary group.

2. The online method of communication of claim 1, further comprising establishing a hierarchy within the group, the hierarchy having at least one moderator authorized to approve, deny, edit, and return any message proposed by a member of the group.

3. The online method of communication of claim 2, further comprising transmitting an approved message to the at least one recipient, the approved message being transmitted and viewed by the at least one recipient as coming from the unitary group.

4. The online method of communication of claim 1, further comprising permitting a member of the group to transmit the outgoing communication to the at least one recipient, the outgoing communication being transmitted and viewed by the at least one recipient as coming from the unitary group.

5. The online method of communication of claim 1, further comprising transmitting the outgoing communication such that the at least one recipient only sees that the outgoing message was sent by the unitary group.

6. The online method of communication of claim 1, further comprising preventing individual members of the group from sending the outgoing communication so that the outgoing message is seen as coming from the individual member.

7. The online method of communication of claim 6, further comprising routing the outgoing communication sent by the individual member so that the outgoing message is seen as coming from the individual member, the outgoing communication being routed to the group administrator.

8. The online method of communication of claim 7, further comprising approving the outgoing message coming from the individual member and transmitting the outgoing message such that the at least one recipient only sees that the outgoing message was sent by the unitary group.

9. The online method of communication of claim 7, further comprising rejecting the outgoing message coming from the individual member and preventing the outgoing message from being transmitted.

10. The online method of communication of claim 1, further comprising identifying the outgoing communication as coming from the unitary group.

11. The online method of communication of claim 1, further comprising filling out information for the group by the group administrator.

12. The online method of communication of claim 11, further comprising becoming the group administrator by initially starting the group.

13. The online method of communication of claim 12, further comprising authorizing the at least one user to also serve as the group administrator.

14. An online method of communication, comprising:
creating a group via a group administrator on a server;
designating group properties;
authorizing at least one user, in addition to the group administrator, to join the group;
transmitting an outgoing communication as a unitary group to at least one recipient, the at least one recipient receiving and viewing the outgoing communication as emanating from the unitary group;
further comprising establishing a hierarchy within the group, the hierarchy having at least one moderator authorized to approve, deny, edit, and return any message proposed by a member of the group;
further comprising transmitting an approved message to the at least one recipient, the approved message being transmitted and viewed by the at least one recipient as coming from the unitary group;
further comprising permitting a member of the group to transmit the outgoing communication to the at least one recipient, the outgoing communication being transmitted and viewed by the at least one recipient as coming from the unitary group;
further comprising transmitting the outgoing communication such that the at least one recipient only sees that the outgoing message was sent by the unitary group;
further comprising preventing individual members of the group from sending the outgoing communication so that the outgoing message is seen as coming from the individual member;
further comprising routing the outgoing communication sent by the individual member so that the outgoing message is seen as coming from the individual member, the outgoing communication being routed to the group administrator;
further comprising approving the outgoing message coming from the individual member and transmitting the outgoing message such that the at least one recipient only sees that the outgoing message was sent by the unitary group;
further comprising rejecting the outgoing message coming from the individual member and preventing the outgoing message from being transmitted;
further comprising identifying the outgoing communication as coming from the unitary group;
further comprising filling out information for the group by the group administrator;
further comprising becoming the group administrator by initially starting the group; and
further comprising authorizing the at least one user to also serve as the group administrator.

15. An online method of communication, comprising:
creating a group via a group administrator on a server;
designating group properties;
authorizing at least one user, in addition to the group administrator, to join the group;
transmitting an outgoing communication as a first unitary group to at least one recipient, the at least one recipient receiving and viewing the outgoing communication as emanating from the first unitary group; and
receiving the outgoing communication by the at least one recipient, the at least one recipient being a second unitary group.
